(19) United States
(12) Patent Application Publication
(10) Pub. No.: US 2003/0171443 A1
(43) Pub. Date: Sep. 11, 2003

(54) Polymeric anion exchanger resins and their utilization in chromatographic methods

(76) Inventor: Christoph Erbacher, Haan (DE)

Correspondence Address: Leon R Yankwich, Yankwich & Associates, 201 Broadway, Cambridge, MA, 02139, US

(21) Appl. No.: 10/220,657

(22) PCT Filed: Feb. 16, 2001
(86) PCT No.: PCT/EP01/01791

(30) Foreign Application Priority Data
Mar. 3, 2000 (DE) 100 09 982.3

(51) Int. Cl. C08J 5/20

(52) U.S. Cl. 521/27; 521/25; 526/303.1; 526/319

(57) ABSTRACT

The invention concerns an anion-exchange resin and its use as a polymeric anion-exchange agent in chromatographic procedures, especially for the purification and isolation of nucleic acids, as well as a chromatographic procedure, especially for the purification and isolation of nucleic acids. The invention further relates to a process for the production of the anion-exchange resin

The subject of the invention are anion-exchange resins, in which the anion-exchange resin is obtainable by the polymerisation of at least one acrylic acid derivative, with the use of at least one cross-linking agent.

The acrylic acid derivative has the general formula (I):

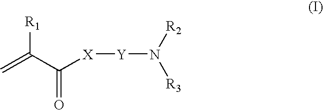

and the cross-linking agent that is used in the polymerisation is described by means of the general formula (III):

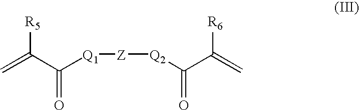

The present invention relates to an anionic exchange resin, its use as a polymeric anion-exchange medium in chromatographic procedures, especially for the purification and isolation of nucleic acids, as well as to a chromatographic process, especially for the purification and isolation of nucleic acids. The invention relates, further, to a process for the manufacture of the anion-exchange resin. In addition, the invention relates to a kit for the isolation and/or purification of nucleic acids, to a pharmaceutical compound, a diagnostic compound and a compound for research purposes, that contain the anion-exchange resin.

Chromatographic procedures for the isolation, separation and analysis of molecular species such, for example, as macro-molecules, have become established in the chemical, bio-chemical, molecular biological and polymer research sectors, or in their utilization in technical processes, in medical, pharmaceutical and genetic technologies.

Of the multiplicity of different, known chromatographic processes, ion-exchange chromatography is especially significant for the purification and isolation of molecular species that contain charged centres such, for example, as ions, proteins or other bio-polymers. In biological sciences as in medicine, the purification and isolation of high-molecular nucleic acids is a key step towards resolving numerous preparatory and analytical problems.

In addition to the utilization here of gel-permeation-chromatography (GPC) and reverse-phase chromatography (RPC), ion-exchange chromatography is especially important. This can be used with particular success for the separation of complex mixtures of different nucleic acids such, for example, as those present in bacterial lysates or in other biological samples.

Frequently, ion-exchange materials known from the prior art such, for example, as polymer resins based on poly-acrylate, exhibit only a small selectivity in respect of different nucleic acid species. As a result, the nucleic acid that is to be separated such, for example, as p-DNA may be contaminated with other nucleic acids such, for example, as RNA. Consequently, costly pre- or post-treatment stages will be necessary in order to obtain the nucleic acid species in a highly pure form. Such additional treatment stages may comprise, for example, further chromatographic stages, precipitation stages, extraction stages or an enzymatic disintegration. Such treatments are time consuming, costly and frequently utilize toxic or carcinogenic chemicals. In addition, they further complicate the purification process so that the automatic intervention of an analytical or production process is made difficult.

Of particular interest for genetic technology is the availability of highly purified vectors such, for example, as plasmid-DNA (p-DNA). For this it is essential to separate the p-DNA, as far as possible selectively, from the residual cell components, especially from proteins, oligonucleotides such, for example, as tRNA, rRNA and phage-DNA

In WO 99/16869 a process is described for the purification of plasma-DNA. This process comprises a precipitation stage in which RNA and chromosomal DNA are separated from the lysate by means of a divalent alkaline earth metal ion before the purified lysate is passed onto an anion-exchange matrix.

A further disadvantage of many ion-exchange materials that are known from the prior art, especially of polymer resins based on polystyrene, is that they bind single strand nucleic acids more firmly than double strand, circular forms. Since p-DNA, in general, is present in the double-strand, circular form, such materials are not suitable for the separation of p-DNA because the binding capacity of the ion-exchange material is blocked by the undesirable single strand nucleic acids, especially RNA, that are normally present in substantial amounts.

Frequently, common ion-exchange materials exhibit only a relatively low binding capacity for nucleic acids in respect of the nucleic acid species that is to be isolated. This low binding capacity necessitates the use of a relatively large chromatograph column volume for the preparatory separation of a defined quantity of nucleic acid. Because of this, the time and material requirements for the individual stages of the chromatographic process such, for example, as the equilibration or washing of the column and the elution of the nucleic acid, are increased.

WO 97/29825 describes a chromatographic separation method for peptides and nucleic acids, in which a weak anion-exchange material is used. Because of the special composition of the ligand group, a strong exchange action between the ligand and the peptide or the nucleic acid, is achieved. This separation method is the preferred method for the purification and isolation of oligonucleotides that contain less than 200 bases and base pairs. The purification and isolation of higher molecular nucleic acids is not demonstrated.

A further disadvantage of common chromatography materials is that these can frequently only be used for a particular chromatographic process. Thus, for example, many chromatography materials possess too low a compression strength for them to be suitable for use in high-pressure liquid chromatography (HPLC).

S.Xie et al. (J. Polym. Sci. A.: Polym. Chem. 35, 1013-1021, 1997) describe the preparation of porous, hydrophilic columns based on polyacrylamide for use in HPLC processes. Polyacrylamide has been used until the present time above all for the electrophoretic separation or filtration of bio-polymers. Through the co-polymerisation of acrylamide with N,N′-ethylene-bis-acrylamide in the presence of higher aliphatic alcohols and poly-ethylene-glycols, columns are obtained having pores with pore diameters in excess of 1000 nm. In this way, the column achieves adequate permeability for liquids. As hypothetical areas for its utilization, the separation of biological polymers, solid phase extractions or the immobilization of proteins is mentioned without further explanation or experimental evidence.

Depending on the material used, common ion-exchange materials can, under certain circumstances, only be used in the form of particles. This prevents their use in other forms such, for example, as monolithic columns or as coatings for carrier materials.

A further problem that can arise with common ion-exchange materials is a deficiency of acid- or base resistance. Such a deficient resistance can be found when the material contains hydrolytic, relatively unstable bond types such, for example, as siloxane bonds. Acid- or base-resistance of the material is always important when large quantities of chromatographic material are required for purification and isolation procedures. This is especially so in the case preparatory processes such, for example, as the production of plasmids. Before any re-use of chromatographic material, it has to be cleaned thoroughly by washing with an alkali or acid in such a manner as to avoid damage to the material. The possibility of re-using the material adds substantially to a reduction in costs, since the emptying and re-filling of high-volume chromatographic columns is expensive and time-consuming.

For this reason, the aim of the present invention is to provide an anion-exchange material, especially for use in chromatographic processes, that substantially reduces the above mentioned disadvantages or avoids them altogether. It is the particular aim to provide an anion-exchange material for use in the purification and isolation of nucleic acids, that exhibits a high degree of selectivity and bonding capacity in respect of individual nucleic acid species, especially in respect of p-DNA.

This aim is achieved by the invention by the anion-exchange resin described in the independent claim 1, by the use of an anion-exchange resin in a chromatographic process described in claim 22, by the kit used for the isolation and/or the purification of nucleic acids as claimed in the independent claim 27, by the pharmaceutical procedure described in the independent claim 29, by the diagnostic procedure described in the independent claim 30, by the research procedure described in the independent claim 31, and by the process for the production of an anion-exchange resin as described in the independent claim 32.

The aim is realized according to the invention through the preparation of an anion-exchange resin, according to which the anion-exchange resin is obtained by the polymerisation of at least one acrylic acid derivative together with at least one cross-linking agent.

The acrylic acid derivative has the general formula (I):

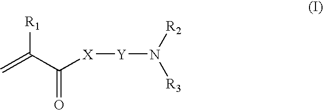

In which formula (1) R₁ represents hydrogen, a methyl or an ethyl group, and R₂ and R₃, independently from one another, represent Hydrogen, a C₁-C₃-alkyl group or a hydroxyl-substituted C₁-C₃-alkyl group. X represents oxygen, an —(NH)— group or an —(NR₁)— group and R₁ represents a C₁-C₃-alkyl group. The acrylic acid derivative can be selected from any of the groups of acrylic acid esters or acrylic acid amide derivatives. Y represents a group (CH₂)ₘ—(CR₂O)ₙ—, in which m, n, independently from one another, represent a whole number 0, 1, 2, 3, 4, 5 or 6, m+n>0 and one or both of the hydrogen atoms in the Y group can be replaced by a C₁-C₃-alkyl group or by an acrylic acid derivative of the general formula (II):

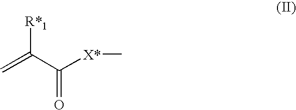

In the general formula (II), R*₁ represents hydrogen, a methyl- or an ethyl group, and X* represents oxygen or an —(NH)— group. The group represented by the formula (II) is itself also selected from the groups of acrylic acid esters or acrylic acid amides, or from their derivatives.

The cross-linking agent used in the polymerisation process is represented by the general formula (III):

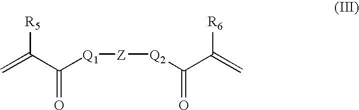

In this formula, R₅ and R₆, independently from one another, represent hydrogen, a methyl- or an ethyl group; Q₁ and Q₂, independently from one another, represent oxygen or an —(NH)-group. Z represents a ([(CH₂)ₒ]—O)ₚ—(CH₂)_{q} group, in which o, p and q, independently from one another, represent a whole number 0, 1, 2 or 3, and o+p+q>o and at least one of the hydrogen atoms in the group Z, independently from one another, can be replaced by a C₁-C₃-alkyl group or by a —[(CH₂)ᵣ—O]ₛ—(CH₂)ₜ—NR₆R₅ group, in which r, s and t, independently from one another, represent a whole number 0, 1, 2, 3, 4, 5 or 6; where r+s+t>0, and R₆ and R₅, independently from one another, represent hydrogen, a C₁-C₃-alkyl group or a hydroxyl-substituted C₁-C₃-alkyl group.

A C₁-C₃-alkyl group, according to the present invention, means a methyl-, ethyl-, -n-propyl- or iso-propyl group.

The polymers obtained in this way comprising weak anion exchange agents, in which the tertiary amino groups that are present at pH values below their pKₚ-value, mainly in the protonated form, can act as anion-exchange groups.

The purification and isolation of certain molecular species that are derived from particular nucleic acid species from a complex mixture, is achieved in such a way that the different components of the mixture react reciprocally with the anion-exchange groups, and that the respective interaction of the different components, that is to say the different molecular species, is of varying intensity. By way of this separating action, for example, one or several nucleic acid species, such, for example, as E.coli proteins, oligonucleotides, tRNA, r-RNA, phage-DNA and/or plasmid-DNA (pDNA) can be isolated from a greater or lesser complex mixture of substances.

This is utilized in a particularly favoured embodiment of the present invention, in which the anion-exchange resin is used in a chromatographic process, by which nucleic acids are separated, isolated, analysed and/or purified from a nucleic acid-containing mixture

Particularly favoured for this method, is the separation and isolation or purification of nucleic acid species of high molecular weight, especially plasmid-DNA.

The separation action of anion-exchange resins permits its use according to the present invention, in purification procedures, analytical and/or preparative processes.

According to a preferred use as described in the present invention, the anion-exchange resin is used in an automated purification process and/or isolation process and/or in an analytical procedure.

The anion-exchange material, according to the present invention, has a high resistance towards acids and bases, which allows it to be re-used and permits material present in the chromatographic column to be washed out (“cleaning in place”).

In a further, preferred embodiment, the anion-exchange resin used can be obtained by a radical polymerisation, especially by a radical co-polymerisation reaction. By means of such a reaction procedure, preferred radical starting materials such, for example, as benzoyl peroxide, azo-isobutyro-nitrile (AIBN) and/or ammonium peroxide disulphate are used. Apart from the preferred radical polymerisation or co-polymerisation reactions, other reaction procedures can also be used such, for example, as anionic, cationic or also coordinative polymerisation. Thus, the polymerisation itself can also be carried out, amongst other methods, by means of suspension- or emulsion-polymerisation.

Suitable solvents that can be used are those solvents known in the prior art for this type of polymerisation reaction.

As solvents for the radical polymerisation reactions, protic or aprotic solvents can be used, especially water, methanol, ethanol, propanol, iso-propanol, ethylene glycol, ethylene glycol mono-alkyl-ether, glycerine, dimethyl formamide and/or dimethyl sulphoxide.

In a particularly preferred embodiment of the present invention, the anion-exchange resin used is obtained through the polymerisation being carried out in the presence, additionally, of a pore-forming agent. By using a pore-forming agent, the anion-exchange resin is provided with pores which increase the surface area of the resin, that is available for binding or adsorption and increases the achievable degree of separation.

According to a further, preferred embodiment of the present invention, the reaction mixture from which the anion-exchange resin is obtained, contains between 0.1 and 100, preferably between0.1 and 75, especially preferably between 4.0 and 20, and even more preferably 16.5% by weight of acrylic acid derivative; between 0 and 95, preferably between 0 and 75, especially preferably between 10 and 23, and most especially preferably 13.5% by weight of cross-linking agent; between 0 and 75, preferably between 0 and 60, especially preferably between 3 and 60 and even more especially preferably 49% by weight of solvent. Optionally, the reaction mixture also contains between 0 and 75, preferably between 0 and 50, especially preferably between 3 and 35 and most especially preferably 21% by weight of pore-forming agent. In all cases, the components of the reaction mixture add up to 100% by weight.

The selective chromatographic separation achieved by the anion-exchange resin of the present invention, results from the choice of suitable buffer systems or elution medium used. For the separation and isolation of different species of nucleic acid, ion-containing buffer systems or elution media are preferably used, that have a conductivity of between 0 and 120 mS/cm.

The term ‘conductivity’ as used in the present invention, is meant to be understood as the capacity of ions to migrate under the influence of an electrical field. Thus, cations move in the direction of the negatively charged electrode, anions in the direction of the positively charged electrode.

The conductivity of an ion-containing solution generally depends on the number of ions present in the solution, on their charge and on the temperature of the solution. The unit of conductivity is ‘S/m’.

In a preferred embodiment, solutions of salts of inorganic acids are used as elution media for the chromatographic separation of nucleic acid species. Especially preferred, are salts having anions of the halide group, nitrates sulphates, etc. and whose cations are chosen from the alkali-, alkali-earth- or ammonium ion groups.

In addition, all other ion solutions that are not explicitly mentioned, but whose conductivity is within the range mentioned above, can be used as elution media.

Furthermore, the anion-exchange medium possesses a high binding capacity for nucleic acids and thus permits a reduction in the amount of resin necessary for the purification and isolation as well as in the volume of chromatographic column used. As a result, the chromatography stages of the process, such as the equilibration of the column, washing of the column and elution of the nucleic acid species, benefit from a correspondingly reduced operation time. In comparison with anion-exchange media based on silica, a reduction in volume of the chromatographic column by a factor of between 4 and 10 can be achieved. According to another, preferred embodiment of the present invention, an anion-exchange resin is used in which the X in the formula (I) represents an —NH)-group or an —(NR₁)-group, in which R₁ is a C₁-C₃-alkyl group, and so that the acrylic acid derivative used in the polymerisation is an acrylic acid amide. Preferably, the cross-linking agent used has the general formula (III), in which Q₁ and/or Q₂ represent oxygen. The anion-exchange materials obtained in this way, exhibit, in the following elutant series, increasing conductivities: E.coli proteins, oligonucleotides (up to 18-mers), tRNA, rRNA, phage-DNA and pDNA are successively de-adsorbed, in the above-mentioned order, from the anion-exchange resin.

In an especially preferred embodiment of the present invention, the anion-exchange resin for the isolation of pDNA is used, being especially preferred for the isolation of pDNA from E.coli lysates. In comparison to pDNA, RNA is present in a 10- to 50-fold excess in E.coli. It is preferred that there is a stronger adsorption of RNA in comparison with DNA on the anion-exchange resin, this would result in loss of yield of pDNA as soon as the limits of capacity of the polymer are reached. In this case, the anion-exchange groups of the polymer would be blocked by a preferred reciprocal action with the existing excess of RNA, and would no longer be available for adsorption of pDNA. Thus, the anion-exchange resins used in accordance with the present invention, offer the possibility of removing those, weaker components of the applied samples bound to the anion-exchange groups such, for example, as proteins, oligonucleotides or RNA, at only a minimal operating cost by, for example, the stepwise gradient concentration or conductivity in the elution medium, that must be selected in such a manner as to ensure that the pDNA that is to be isolated, initially remains bound. In this way, the binding capacity of the anion-exchange resin in respect of the most strongly bound nucleic acid species that is to be isolated such, for example, as pDNA, is used optimally. The elution of the species that is to be isolated can then be accomplished, for example, by raising the concentration of ions and thereby the conductivity of the elution medium.

In a further, preferred embodiment of the present invention, an acrylic acid derivative used for the polymerisation, is selected from the following group:

N-[3-(N,N-dimethylamino)propyl]methacrylamide,

N-[3-(N,N-diethylamino)propyl]methacrylamide,

N-[2-(N,N-dimethylamino)ethyl]methacrylamide

N-[2-(N,N-diethylamino)ethyl]methacrylamide. Especially preferred is N-[3-(N,N-dimethylamino)propyl]methacrylamide as the acrylic acid derivative used.

In an alternative preferred embodiment of the invention, for use in the polymerisation, is an acrylic acid derivative selected from the group comprising 2-aminoethyl-methacrylate, 2-(N,N-dimethylamino)ethylacrylate, 2-(N,N-dimethylamino)ethylmethacrylate and 3-(N,N-dimethylamino)neopentylmethacrylate.

According to a further especially preferred embodiment of the present invention, alkylene-glycol-diacrylatyes, or dialkylene-glycol-diacrylates are used as cross-linking agents, especially cross-linking agents selected from the group comprising Ethylene-glycol-dimethacrylate, 2,2-dimethyl-1,3-propanediol-diacrylate, 2,2-dimethyl-1,3-propanediol-dimethacrylate, diethylene-glycol-diacrylate, diethylene-glycol-dimethacrylate, ethylene-glycol-diacrylate, dipropylene-glycol-dimethacrylate and 3-(N,N-dimethylaminopropyl)-1,2-diacrylate. Especially preferred for this is the use of ethylene-glycoldimethacrylate as a cross-linking agent.

With the use of these cross-linking agents, anion-exchange resins are obtained that have an especially good mechanical stability and a high porosity.

According to a further variation of the invention, an anion-exchange resin is used in which the acrylic acid derivative and the cross-linking agent used is 3-(N,N-dimethylaminopropyl)-1,2-diacrylate. The anion-exchange resin thus obtained will in this case not be derived from a co-polymerisation but by polymerisation of only a single monomeric species.

For the polymerisation, a pore-promoting agent can be present which, for example, comprises an aliphatic alcohol and/or a polymeric compound. Such pore-promoting agents are known in the prior art. As pore-promoting agent used in a further, especially preferred embodiment of the present invention, are aliphatic, branched or un-branched alcohols having 4 to 20 C-atoms, preferably 4 to 16-C-atoms and especially preferably 4 to 8-C-atoms with one or more hydroxyl groups, preferably 1-3 hydroxyl groups or polymeric compounds whose mean molecular mass, M_{w}, lies between 200 and 100,000 g/mol, and that are selected from the group comprising poly-alkylene-glycol derivatives, poly-ethylene-imines, poly-vinyl-pyrollidone and polystyrene.

According to the present invention, especially favoured pore-promoting agents are used that are selected from the group comprising polyethylene-glycol (M_{w}: 200-10,000 g/mol), polypropylene-glycol (M_{w}: 200-10,000), polyethylene-glycol-monoalkylether (M_{w}: 200-5,000), polyethylene-glycol-dialkylether (M_{w}: 200-5,000 g/mol), Polyethylene-glycol-monoalkylether (M_{w}: 200-20,000 g/mol), polyethylene-glycol-dialkylester (M_{w}: 200-5,000 g/mol), polyethylene-glycol-diacid (M_{w}: 1,000-20,000 g/mol), polyethylene-imine (M_{w}: 200-10,000), polyvinyl-pyrrolidone (M_{w}: 10,000-40,000) and/or polystyrene (M_{w}: 200-5,000 g/mol).

Especially favoured for use as pore-promoting agent in the present invention is polyethylene-glycol (Mw: 1,000-6,000

In a further preferred embodiment of the present invention, the anion-exchange resin is used in the form of particles, in which the particle size lies between 1 and 10,000 μm. In order to obtain the anion-exchange resin in the desired particle form, the polymerisate can be washed, milled and sieved after successful completion of the polymerisation reaction which can take between 12 and 28 hours. For the use of the anion-exchange resin of the present invention in analytical applications, it is preferable to use smaller particle sizes, whereas for preparative purposes such, for example, as for “gravity flow” columns, larger particle sizes are preferred.

The anion-exchange resin can be used in a multiplicity of forms. According to the invention, it can be used in the form of a filter, a membrane or as a monolithic column. The membrane and/or filter can comprise very different diameters and layer thicknesses.

Thus, the layer thickness can, for example, be between 0.1 and 2 mm. It is also possible to combine several membrane or filter layers.

According to a further, especially preferred embodiment of the present invention, the anion-exchange resin is present as a coating on a carrier material. The carrier material used can comprise porous or non-porous, inorganic or organic solid materials. The carrier material used can, for example, be diatomaceous-earth, kieselguhr, TiO₂, ZrO₂ or polymers. The carrier material can be used in the form of particles such, for example, as broken polymer particles, or as spherical particles. Apart from these, it can also be used in other forms such, for example, as fibres, films or membranes.

The possibility to use it as a layer on carrier materials has the advantage that the anion-exchange material can be utilized in a number of different ways. In addition to the classical use in column-chromatography with packed columns, it is also possible to use it in other chromatographic processes. The possible use of carrier materials with high specific densities such, for example, as TiO₂, in the form of particles, permits the use of the anion-exchange resins of the present invention in ‘Expanded Bed’-chromatography. On the other hand, the use of coated membranes allows for its use in ‘Simulated Moving Bed’-chromatography.

In addition, according to the present invention, the anion-exchange material can be used as a filler for porous, inorganic or organic solids or solid surfaces.

As a further component of the present invention, a chromatographic process is presented that has the following stages:

a) The application of a sample containing at least one nucleic acid species onto a stationary phase, whereby the stationary phase comprises an anion-exchange resin as defined in any of the claims 1 to 21, and

b) elution of the at least one nucleic acid species by means of an eluant.

In one embodiment of the process according to the present invention, the eluant used is an ion-containing solution. According to an especially favoured variation of the process according to the invention, the conductivity of the eluant is continuously changed from a lower limiting value that corresponds to the conductivity of water or of a salt-free eluant, up to 120 mS/cm or higher. The change in the conductivity can be achieved through an increase in the ion concentration of the eluant, for example by means of a linear gradient. Alternatively, the conductivity of the eluant can be changed stepwise during the elution stages, that is by means of a staged gradient.

It is especially favourable for the conductivity to be changed by means of an increase in the ion concentration in an NaCl salt solution of 0-2,000 mM, during the stages of the elution process.

The changing of the conductivity of the eluant is adjusted to the adsorption characteristic of the nucleic acid species on the anion-exchange resin, that is to be isolated. The increase of the conductivity of the eluant during the elution stages is always then advantageous for the separation or purification, isolation or analysis where the nucleic acid species that is to be separated is adsorbed at a lower conductivity corresponding, for example, to that of water or of a salt-free eluant, up to 60 mS/cm, and is only de-adsorbed again at higher conductivities of the eluant, for example, up to 120 mS/cm or higher.

In an especially favoured embodiment of the process, the nucleic acid-containing sample is a bacterial lysate, especially an E.coli lysate. Especially favoured by the process according to the present invention is the purification or isolation of plasmid-DNA. In addition, the process according to the present invention can be used in the area of analytical procedures or for production processes.

According to the present invention, the anion-exchange resins are used as kits for the isolation and/or purification of nucleic acids, especially high-molecular nucleic acids, that favour the additional presence of appropriate buffers. The kit can, additionally, comprise appropriate components for supporting the lysis, and/or contain material providing a mechanical effect and/or components for enzymatic treatment of the sample.

In accordance with present invention, the above-specified anion-exchange resins can be utilized in pharmaceutical applications, in diagnostic applications, which diagnostic applications are to include diagnostics in medical-pharmaceutical sectors as well as analyses of food- and environmental samples, and also has applications in research.

Within the scope of the materials claimed in the present invention, are also included the processes for the manufacture of all above-mentioned specific anion-exchange resins.

The present invention is illustrated further by way of the following embodiments and drawings.

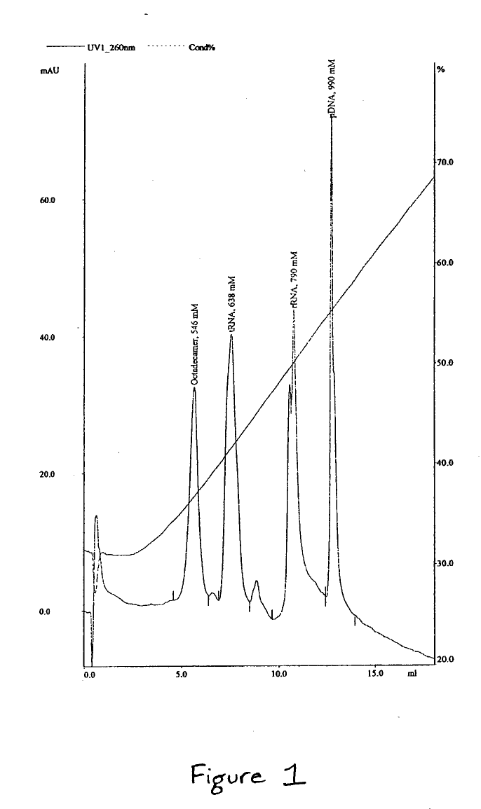

FIGS. 1 to 9 are graphic representations of various elution profiles of different anion-exchange materials according to the invention under different elution conditions.

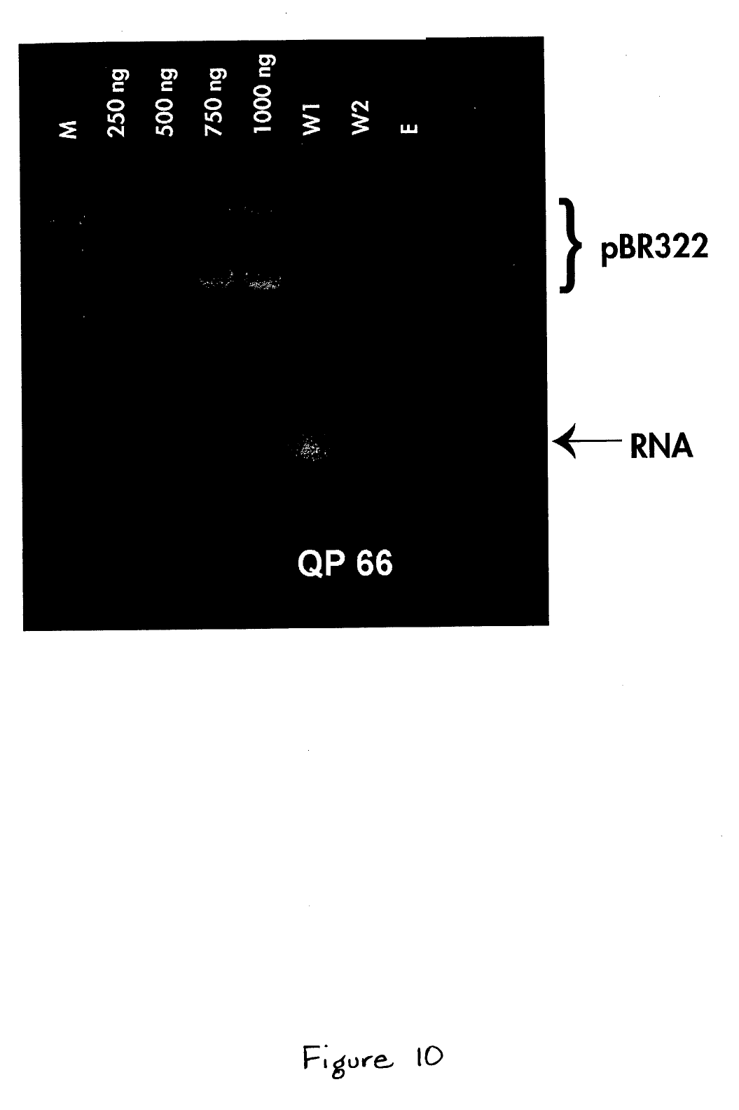

FIG. 10 is an agar gel of pBR322 preparations.

The anion-exchange resins of the present invention are illustrated by means of the Examples 1.1 to 1.6.

In general, the synthesis of the anion-exchange materials comprises, according to the invention, the radical polymerisation in the following stages: a) If necessary, the de-protection of the monomer, that is of the acrylic acid derivative and/or of the cross-linking agent; b) Preparation of the monomeric mixture; c) Addition of the solvent and radical starter, and optional addition of a pore-promoting agent; d) De-gassing of the reaction mixture; and e) Polymerisation at 60° C., over a period of 12 to 24 hours.

In order to obtain the prepared polymerizate, in a particle form, it can subsequently be milled and washed, and graded by means of wet-sieving.

Table 1 presents the elution characteristics of the anion-exchange resins described in the Examples 1.1 to 6, for DNA/RNA separation and isolation, as well as of other examples according to the present invention. Different pore-promoting agents were used in the synthesis of the resins and/or the composition of the reaction mixture was varied. The coating of TiO₂ particles or of SiO₂ particles with the anion-exchange resins of the present invention is described in the Examples 2 and 3. In general, the method of coating the carrier materials with the anion-exchange resins according to the invention comprises the following stages: a) If necessary, loading the carrier particles with a radical starter; b) Addition of the monomers, that is of the acrylic acid derivative, the cross-linking agent, the pore-promoting agent and the solvent; c) Thorough mixing of the reaction mixture; d) Removal of the excess reaction mixture from the carrier particles; e) Polymerisation at 60° C. over a period of from 12 to 24 hours; and f) Washing of the coated carrier material.

With TiO₂ particles, the coating is achieved through cross-linking of the particles with the reaction mixture and the subsequent polymerisation.

The selectivity of the anion-exchange particles for the different nucleic acids (oligo-nucleotide (18-mer), tRNA, rRNA (16S/23S), M 13 DNA, pDNA) is elucidated by means of the chromatograms of Example 4 illustrated in the FIGS. 1 to 9. Example 5 illustrates how the anion-exchange resin can be used for the preparation of pDNA from clarified bacterial lysate in accordance with the invention. The identity and purity of the isolated pDNA was confirmed by means of agar gel electrophoresis and poly-acrylamide gel electrophoresis (see FIGS. 10 and 11).

In addition, determination of the static and dynamic pDNA binding capacity is described in the Examples 6 and 7, and the binding capacities of several, selected anion-exchange resins are given.

Although applications of the polymer are only given as examples of broken particles and coated, porous, inorganic carrier particles, other preparation types of the polymers can be obtained by means of the present invention without substantially altering the given properties such as the binding capacity and the chromatographic selectivity. Other preparation structures would be, for example, the use of the polymer as a coating on porous, organic carrier particles, or for coating non-porous surfaces of inorganic or organic solids. The polymer of the present invention can also be used in the form of membranes having different diameters and layer thicknesses, or can be used in the form of spherical particles with a wide variety of particle sizes.

The percentage figures refer to percentage by weight (w/w) unless otherwise indicated.

### EXAMPLE 1

Preparation of Polymeric Anion-Exchange Resins in Accordance with the Present Invention

### EXAMPLE 1.1

Co-Polymerisation of 2-(N,N-dimethylamino)-ethyl Acrylate with Ethylene-Glycol Dimethacrylate:

1.5 ml of dimethylamino acrylate was measured into a 10 ml measuring cylinder and ethylene-glycol dimethacrylate was added up to a volume of 10 ml. (Solution I). 6 ml of 1-hexanol was measured into a 25 ml measuring cylinder and dimethyl sulphoxide was added up to a volume of 20 ml. (Solution II). 7.5 ml of the solution I and 17.5 ml of the solution II were pipetted onto 66 mg of azo-isobutyro-nitrile in a 50 ml round bottom flask. The mixture was de-gassed (for example, by three ‘freeze pump thaw’ cycles), flushed with argon and polymerised at 60° C. for 24 hours. (Resin Index: QP3).

### EXAMPLE 1.2

Co-Polymerisation of N-(3-(dimethyl-amino)propyl) Methacrylamide with Ethylene-Glycol Dimethacrylate:

A solution of N-(3-(dimethyl-amino)propyl) methacrylamide (19.5%), ethylene-glycol dimethacrylate (10.5%) and polyethylene-glycol (M_{w}: 3000) (21%) in methanol (49%) was prepared. (The percentages are percentages by weight in relation to the weight of the solution). 25 mg of AIBN were added to 10 ml of that solution. The resulting solution was flushed with argon and then heated at 60° C. for 24 hours. (Resin Index: QP66).

### EXAMPLE 1.3

Co-polymerisation of N-(3-(dimethyl-amino)propyl) Methacrylamide with Ethylene-Glycol Dimethacrylate

A solution of N-(3-(dimethyl-amino)propyl) methacrylamide (15%), ethylene-glycol dimethacrylate (15%) and polyethylene-glycol (M_{w}: 3000) (17.5%) was prepared in methanol (52.5%). (Percentages are percentages by weight in relation to the weight of the solution). 25 mg of AIBN (azo-isobutyro-nitrile) was added to 10 ml of the solution. The resulting solution was flushed with argon and then heated at 60° C. for 24 hours. (Resin Index: QP71).

### EXAMPLE 1.4

Co-polymerisation of N-(3-(dimethyl-amino)propyl) Methacrylate with Ethylene-Glycol Dimethacrylate

A solution of N-(3-(dimethyl-amino)propyl) methacrylate (15%), ethylene-glycol dimethacrylate (15%) and polyethylene-glycol (M_{w}: 3000) (17.5%) in methanol (52.5%) was prepared. (Percentages are percentages by weight in relation to the weight of the solution). 25 mg of AIBN was added to 10 ml of this solution. The resulting solution was flushed with argon and then heated at 60° C. for 24 hours. (Resin Index: QP80).

### EXAMPLE 1.5

Co-polymerisation of 2-(N,N-dimethylamino) Ethyl-Acrylate with Pentaerythritol Triacrylate

0.9 ml of 2-(N,N-dimethylamino)ethyl-acrylate was measured into a 5 ml measuring cylinder and made up to 3.0 ml with pentaerythritol triacrylate. 2.4 ml of 1-hexanol was measured into a 10 ml measuring cylinder and made up to 10 ml with dimethyl sulphoxide. To 3.0 ml of the monomeric mixture in a 10 ml measuring cylinder were added the solvent mixture up to a volume of 10 ml. The mixture was transferred into a round bottom flask, de-gassed with three ‘freeze pump thaw’ cycles, flushed with argon and polymerised at 60° C. for 24 hours. (Resin Index: QP4).

Elaboration of the Polymer Product Obtained in the Examples 1.1 to 1.5

The polymer product was washed on a glass filter funnel with acetone, dried and then milled. The required particle size was obtained by means of wet-sieving. The particles were stored under an ethanol/water mixture (20% by volume) until required for further chromatographic characterisation.

### EXAMPLE 1.6

Co-Polymerisation of N-(3-(dimethyl-amino)propyl Methacrylamide with Ethylene-Glycol Dimethacrylate

19.5 ml of N-(3-(dimethyl-amino)propyl methacrylamide, 10.5 ml of ethylene-glycol dimethacrylate, 21 g of polyethylene-glycol (M_{w}: 3000) and 250 mg of azo-isobutyro-nitrile were dissolved in 49 ml of methanol in a 500 ml round bottom flask. Argon was bubbled through the mixture for at least one minute, the flask was sealed with a high-pressure valve, and the mixture was polymerised at 60° C. for 24 hours. The polymerisate was transferred to an extraction capsule and extracted in a soxhlett extractor, firstly with acetone and then with water, in each case for 2 hours. The material was then washed on a filter funnel with methanol and then dried in a vacuum drying oven at 60° C. From 20 g of raw material (still containing methanol and PEG), after extraction and vacuum drying, 4.78 g of polymeric anion-exchange resin was obtained, which, after milling and classification yielded 10 mg of under-size material, 1.38 g (32-90 μm), 0.32 g (90-112 μm) and 2.67 g of over-sized material (Resin Index: QP90).

The polymeric anion-exchange resins described above, as well as others obtainable according to the present invention, and their relevant chromatographic data are presented in Table 1:

Table 1.

| | Cross- | Pore- | | rRna | | DNA-RNA | AcrylicAcid |
|---|---|---|---|---|---|---|---|
| | linking | promoting | Ratio | (16SZ3S) | pDNA | [NaCl]/ | Derivative |
| Resin | agent | agent | % by weight | [NaCl]/[M] | [NaCl]/[M] | [mM] | Comments |
| QP29 | EGDMA* | 1-Butanol | 7.5%: 22.5%: 49%: 21% | 0.785 | 0.836 | 51 | DMAPMAA* |
| QP30 | ″ | 2-Butanol | 7.5%: 22.5%: 49%: 21% | 0.773 | 0.844 | 71 | ″ |
| QP31 | ″ | Hexanol | 7.5%: 22.5%: 49%: 21% | 0.777 | 0.831 | 54 | ″ |
| QP32 | ″ | Heptanol | 7.5%: 22.5%: 49%: 21% | 0.770 | 0.825 | 55 | ″ |
| QP33 | ″ | Octanol | 7.5%: 22.5%: 49%: 21% | 0.775 | 0.831 | 56 | ″ |
| QP34 | ″ | PEG 600 | 7.5%: 22.5%: 49%: 21% | 0.760 | 0.815 | 55 | ″ |
| QP35 | ″ | PEG 2000 | 7.5%: 22.5%: 49%: 21% | 0.722 | 0.785 | 63 | ″ |
| QP36 | ″ | PEG 4000 | 7.5%: 22.5%: 49%: 21% | 0.758 | 0.836 | 78 | ″ |
| QP37 | ″ | PEG 8000 | 7.5%: 22.5%: 49%: 21% | 0.689 | 0.756 | 67 | ″ |
| QP38 | ″ | PEG 20000 | 7.5%: 22.5%: 49%: 21% | 0.663 | 0.731 | 68 | ″ |
| QP40 | ″ | PPG 425 | 7.5%: 22.5%: 49%: 21% | 0.699 | 0.758 | 59 | ″ |
| QP41 | ″ | PPG 725 | 7.5%: 22.5%: 49%: 21% | 0.756 | 0.823 | 67 | ″ |
| QP42 | ″ | PPG 1000 | 7.5%: 22.5%: 49%: 21% | 0.745 | 0.810 | 65 | ″ |
| QP43 | ″ | PPG 2000 | 7.5%: 22.5%: 49%: 21% | 0.747 | 0.814 | 67 | ″ |
| QP44 | ″ | PPG 4000 | 7.5%: 22.5%: 49%: 21% | 0.750 | 0.821 | 71 | ″ |
| QP45 | ″ | PEG 4000 | 4.5%: 25.5%: 49%: 21% | 0.728 | 0.791 | 63 | ″ |
| QP46 | ″ | PEG 4000 | 7.5%: 22.5%: 49%: 21% | 0.743 | 0.815 | 72 | ″ |
| QP47 | ″ | PEG 4000 | 10.5%: 19.5%: 49%: 21% | 0.766 | 0.854 | 88 | ″ |
| QP48 | ″ | PEG 4000 | 7.5%: 22.5%: 49%: 21% | 0.531 | 0.601 | 70 | DEAMPMAA |
| QP49-2 | ″ | PEG 4000 | 10.5%: 19.5%: 49%: 21% | 0.351 | 0.244 | −107 | polymerisation, 1 hr |
| QP49-3 | ″ | PEG 4000 | 10.5%: 19.5%: 49%: 21% | 0.724 | 0.764 | 40 | polymerisation, 3 hrs |
| QP50 | EGDMA/ | PEG 4000 | 10.5%: 18%: 49%: 21% | 0.582 | 0.752 | 70 | DMAPMAA* |
| | 1.5% | | | | | | |
| | Methacryl | | | | | | |
| | acid | | | | | | |
| QP51 | EGDMA | PEG 4000 | 13.5%: 16.5%: 49%: 21% | 0.775 | 0.856 | 81 | ″ |
| QP52 | ″ | PEG 4000 | 16.5%: 13.5%: 49%: 21% | 0.796 | 0.800 | 94 | ″ |
| QP53 | ″ | PEG 4000 | 19.5%: 10.5%: 49%: 21% | 0.796 | 0.890 | 94 | ″ |
| QP56-2 | ″ | PEG 4000 | 15%: 15%: 60.2%: 9.8% | 0.770 | 0.854 | 84 | ″ |
| QP56-3 | ″ | PEG 4000 | 10.5%: 19.5%: 64.4%: | 0.758 | 0.833 | 75 | ″ |
| | | | 5.6% | | | | |
| QP56-4 | ″ | PEG 4000 | 15%: 15%: 63%: 7% | 0.775 | 0.859 | 84 | ″ |
| QP57-2 | ″ | PEG 4000 | 15%: 15%: 47.6%: 22.4% | 0.766 | 0.863 | 97 | ″ |
| QP57-3 | ″ | PEG 4000 | 10.5%: 19.5%: 55.3%: | 0.749 | 0.823 | 74 | ″ |
| | | | 14.7% | | | | |
| QP57-4 | ″ | PEG 4000 | 15%: 15%: 52.5%: 17.5% | 0.771 | 0.861 | 90 | ″ |
| QP58-1 | ″ | PEG 4000 | 19.5%: 10.5%: 39.2%: | 0.787 | 0.890 | 103 | ″ |
| | | | 30.8% | | | | |
| QP58-2 | ″ | PEG 4000 | 15%: 15%: 28.7%: 41.3% | 0.791 | 0.886 | 95 | ″ |
| QP58-3 | ″ | PEG 4000 | 10.5%: 19.5%: 99.2%: | 0.766 | 0.840 | 74 | ″ |
| | | | 30.8% | | | | |

| | | | | | | | |
|---|---|---|---|---|---|---|---|
| QP58-4 | EGDMA | PEG 4000 | 15%: 15%: 35%: 35% | 0.770 | 0.873 | 103 | DMAPMAA* |
| QP58-5 | ″ | PEG 3000 | 50%: 50%: 50%: 50% | 0.787 | 0.892 | 105 | ″ |
| QP58-6 | ″ | PEG 3000 | 15%: 15%: 35%: 35% | 0.764 | 0.863 | 99 | ″ |
| QP59 | DPDA* | PEG 4000 | 10.5%: 1.95%: 49%: 21% | 0.601 | 0.621 | 20 | ″ |
| QP60 | DPDMA* | PEG 4000 | 10.5%: 19.5%: 43%: 21% | 0.739 | 0.817 | 78 | ″ |
| QP62 | DEDMA* | PEG 4000 | 10.5%: 19.5%: 49%: 21% | 0.701 | 0.743 | 42 | ″ |
| QP64 | DPDMA* | PEG 4000 | 10.5%: 19.5%: 48%: 21% | 0.689 | 0.756 | 67 | ″ |
| QP66 | EGPMA | PEG 3000 | 19.5%: 10.5%: 49%: 21% | 0.762 | 0.867 | 105 | ″ |
| QP71 | EGDMA | PEG 3000 | 15%: 15%: 52.2%: 17.5% | 0.770 | 0.867 | 97 | ″ |
| QP71-A | ″ | PEG 3000 | 15%: 15%: 52.5%: 17.5% | 0.747 | 0.842 | 95 | Argon |
| QP71-OA | ″ | PEG 3000 | 15%: 15%: 52.5%: 17.5% | 0.770 | 0.856 | 86 | without argon |
| QP74 | EGDMA/2- | PEG 3000 | 8.8%: 17.6%: 3.5%: 49%: | 0.726 | 0.794 | 68 | |
| | Hydroxy- | | 21% | | | | |
| | ethymonacry | | | | | | |
| | tat | | | | | | |
| QP78-1 | ″ | PEG 3000 | 18%: 12%: 49%: 21% | 0.817 | 0.915 | 98 | |
| QP80 | ″ | PEG 3000 | 15%: 15%: 52.5%: 17.5% | 0.794 | 0.827 | 33 | DMAPMA |
| QP83 | ″ | PEG 3000 | 15%: 15%: 49%: 21% | 0.777 | 0.865 | 88 | 21 times the |
| | | | | | | | starting material |
| QP84 | ″ | PEG 2000 | 15%: 15%: 49%: 21% | 0.798 | 0.867 | 69 | |
| | | Monomethyl- | | | | | |
| | | ether | | | | | |
| QP85 | ″ | PEG 5000 | 15%: 15%: 49%: 21% | 0.768 | 0.835 | 67 | |
| | | Monomethyl- | | | | | |
| | | ether | | | | | |
| QP86 | ″ | PEG 2000 | 15%: 15%: 49%: 21% | 0.808 | 0.882 | 74 | |
| | | Dimethyl- | | | | | |
| | | ether | | | | | |
| QP87 | ″ | Polyvinyl- | 15%: 15%: 49%: 21% | 0.779 | 0.857 | 78 | |
| | | pyrroligon | | | | | |
| QP89 IS | ″ | PEG 3000 | 13.6%: 13.6%: 19.1%: 44.5%: | 0.789 | 0.867 | 78 | |
| | | | 9.1% | | | | |
| QP 92 | EGDMA | PEG 3000 | 15%: 15%: 49%: 21% | | | | DMAPMAA* |
| | | | 5 mg AlBN | | | | |
| QP93 | ″ | PEG 3000 | 15%: 15%: 49%: 21% | 0.814 | 0.898 | 84 | ″ |
| | | | 10 mg AlBN | | | | |
| QP94 | ″ | PEG 3000 | 15%: 15%: 49%: 21% | 0.821 | 0.905 | 84 | ″ |
| | | | 15 mg AlBN | | | | |
| QP95 | ″ | PEG 3000 | 15%: 15%: 49%: 21% | 0.800 | 0.880 | 80 | ″ |
| | | | 20 mg AlBN | | | | |
| QP96 | ″ | PEG 3000 | 15%: 15%: 49%: 21% | 0.810 | 0.888 | 78 | ″ |
| | | | 25 mg AlBN | | | | |
| QP97 | ″ | PEG 3000 | 15%: 15%: 49%: 21% | | | | |
| | | | 50 mg AlBN | | | | |

The abbreviations used in the Table designate the following compounds:

| | |
|---|---|
| EGDMA: | Ethylene-glycol dimethacrylate |
| DPDA: | Dipropylene-glycol diacrylate |
| DPDMA: | Dipropylene-glycol dimethacrylate |
| DEDMA: | Diethylene-glycol dimethacrylate |
| DPDMA: | Dipropylene-glycol dimethacrylate |
| DMAPMAA: | N,N-dimetrhylamino-propyl methacrylamide |
| DEAPMAA: | N,N-diethylamino-propyl methacrylamide |
| DMAPMA: | N,N-dimethylamino-propyl methacrylate |
| PEG: | Polyethylene-glycol (M_{w} in g/mol) |
| PPG: | Polypropylene-glycol M_{w} in g/mol) |
| A: | Acrylic acid derivative |
| B: | Cross-linking agent |
| C: | Solvent |
| D: | Pore-promoting agent |

### EXAMPLE 2

Coating of TiO₂ Particles

2 ml of N-(3-(dimethylamino)-propyl) methacrylamide, 25 mg of AIBN, 1 ml of ethylene-glycol dimethacrylate, and 3 g of polyethylene-glycol (M_{w}: 3000) were dissolved in 8.85 ml of methanol. 8.0 g (4.5 ml) of porous TiO₂-particles (Sachtopore* 40 μm, <5 m²g⁻¹, pore diameter 2000 Å: Sachtleben GmbH) were suspended into this mixture. The excess liquid mixture was sucked off and the TiO₂ together with the liquid mixture was transferred into a 50 ml round bottom flask. The flask was flushed with argon and then heated at 60° C. for 24 hours. On completion of the polymerisation the material was reduced to small pieces in a mortar, and washed with acetone and distilled water. A 32 -90 μm sieve fraction of the product obtained was analysed for its binding capacity and chromatographic properties, (Resin Index: QP66Ti).

### EXAMPLE 3

Coating of SiO₂ Particles

150 mg of sodium peroxide disulphate were dissolved in 6 ml of water, and 2 g S-Gel (Kieselguhr from Chemie Uetikon, 40 μm, 1000 Å) were suspended into the solution. The kieselguhr was sucked off, washed with 4 ml of methanol and then dried. The kieselguhr was then suspended in a mixture comprising 2 ml of N-(3-(dimethylamino)propyl) methacrylamide, 1 ml of ethylene-glycol dimethacrylate, 3 g of polyethylene glycol (M_{w}: 3000) and 8.85 ml of methanol. The suspension was de-gassed at about 18 mbar for 1-2 minutes, and the excess liquid mixture was then sucked off. The treated kieselguhr was then transferred into a round bottom flask and heated at 60° C. for 24 hours. (Resin Index: QP66Si).

### EXAMPLE 4

Chromatographic Characterisation of the Polymeric Anion-Exchangers Described in the Examples 1.1 to 1.6

For the chromatographic characterisation of the separation capacity of the polymeric anion-exchange resins described in the Examples and in the Tables, a 32-90 μm sieve-fraction was in each case in suspension with 20% by volume of ethanol, was packed at a flow rate of up to 10 ml/min into an HR 5/5 column (Amersham Pharmacia) up to a height of 2 cm. The column was then equilibrated with 50 mM of Tris Buffer (tris-[hydroxymethyl]-amino methane). pH: 7.0; 15% by volume of ethanol, and 50 μl of a nucleic acid solution or clarified lysate was added onto the column The nucleic acids were then eluted at a flow rate of 1 ml/min with a linear NaCl gradient.

The chromatograms illustrated in the FIGS. 1 to 9 disclose the dependence of the nucleic acid separation and isolation upon

a) the choice of anion-exchange resin,

b) the choice of gradient for the eluant,

c) the choice of pH value.

For the chromatograms illustrated in the FIGS. 1 to 4, the following parameters were maintained:

FIG. 1: Separation and isolation of nucleic acids on the anion-exchange resin QP66

Sieve fraction: 32-90 μm;

Gradient of the eluant: 400 mM-1040 mM NaCl;

Nucleic acid sample: 18-mer (2 μg), tRNA (7.5 μg), rRNA 16S/23S (45 μg), pDNA (5 μg) in 50 μl buffer (10 mmol. TRIS (tris-[hydroxy-methyl]-amino-methane),

1 mmol EDTA (ethylene-diamine tetra-acetic acid), at pH 8.0.

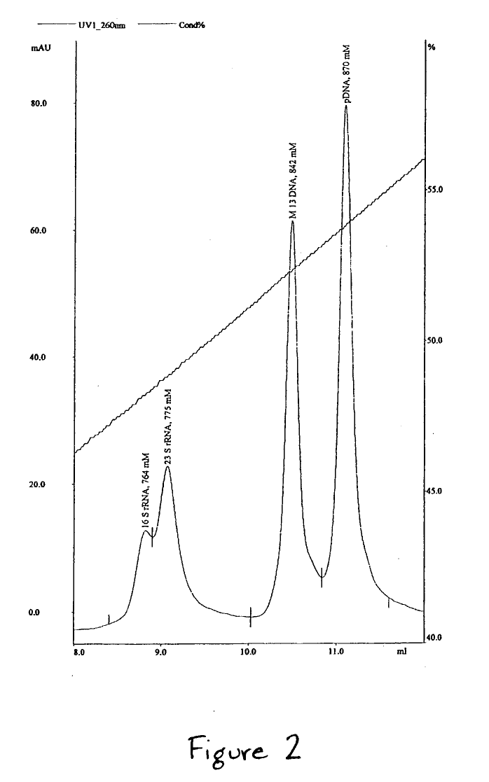

FIG. 2: Separation and Isolation of nucleic acids on the anion-exchange resin QPO71

Sieve fraction: 32-90-μm,

Gradient of the eluant: 840 mM-1100 mM NaCl;

Nucleic acid sample: rRNA 16S/23S (10.0 μg), M13 DNA (6.3 μg), pDNA (4,0 μg) in 50 μl buffer (10 mmol TRIS, 1 mmol EDTA, pH 8).

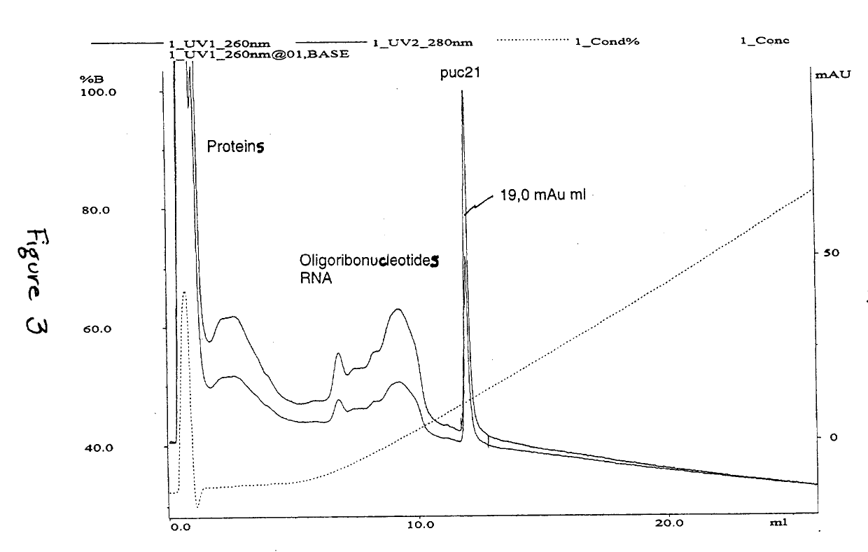

FIG. 3: Purification and Isolation of pDNA of an RNase-digested, clarified lysate of Escherichia coli DH5α (puc21 transformed) (DSM-no. 6897), 50 μl injection volume, anion-exchange resin QP 57-2.

Gradient of the eluant: 400 mM-2000 mM NaCl.

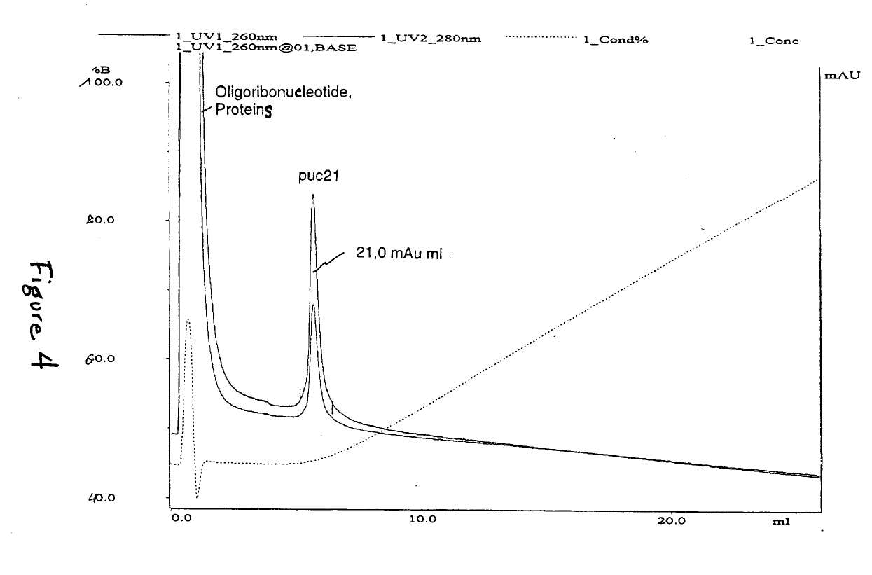

FIG. 4: Purification and Isolation of pDNA of an RNase-digested, clarified lysate of Escherichia coli DH5α (puc21 transformed), 50 μl injection volume, anion-exchange resin QP 57-2;

the column was equilibrated prior to the injection with 800 mM of NaCl.;

Gradient of the eluant, 800 mM-2000 mM NaCl.

The chromatograms illustrated in the FIGS. 1 to 4 clearly show the separation of the different nucleic acid species, and the elution sequence of the different nucleic acid species with increasing salt-gradient in the eluant, that is especially useful for isolation of pDNA.

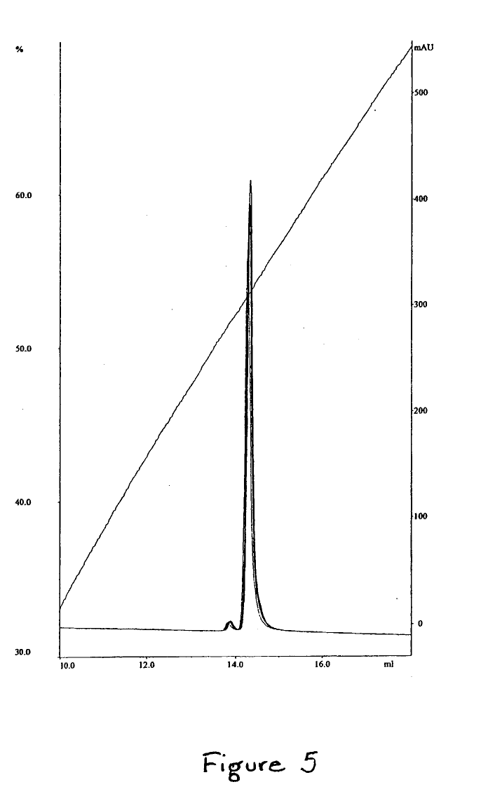

The chromatogram illustrated in, FIG. 5 elucidates the base-stability of the anion-exchange resin used, and thus its re-usability, as well as the possibility to ‘clean-in-place’—CIP. For this, the anion-exchange resin QP71 was washed in an HR5/5 column (Amersham Pharmacia) having 40 to 100 column volume of 0.1 M sodium hydroxide solution with a flow rate of 1 ml/min., and then, respectively, the elution point at puc21 determined. As can be noted from FIG. 5 and Table 3, within the limits of the measurement accuracy, no displacement of the elution point can be seen.

TABLE 3
Cleaning-in-Place

| Column | Elution pDNA |
|---|---|
| Volume | [NaCl]/(mM) |
| 0.1 M NaOH | QP 71, 32-90 μm |
| 40 | 1102 |
| 50 | 1100 |
| 60 | 1104 |
| 70 | 1104 |
| 80 | 1106 |
| 90 | 1104 |
| 100 | 1108 |

The anion-exchange resin was then removed from the HR5/5 column, washed with methanol, then dried and the pDNA binding capacity determined. No reduction in binding capacity could be determined (see Table 6: QP71. QP71CIP).

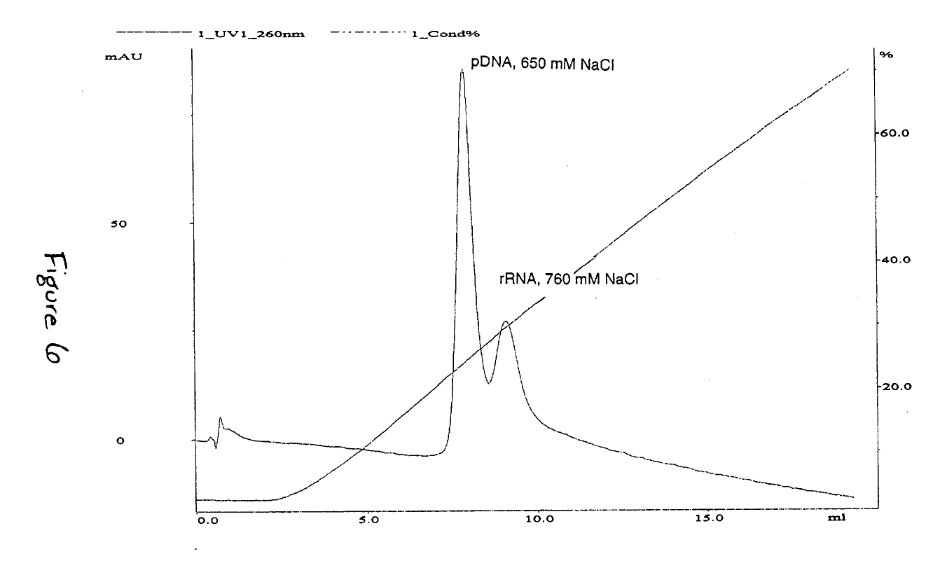

The separation and isolation of pDNA and rRNA onto the anion-exchange resin QP3 is presented in FIG 6.

Sieve fraction: 32-90 μm;

Nucleic acid sample: pDNA, rRNA (16S/23S);

Gradient of the eluant: 0 mM-1200 mM NaCl.

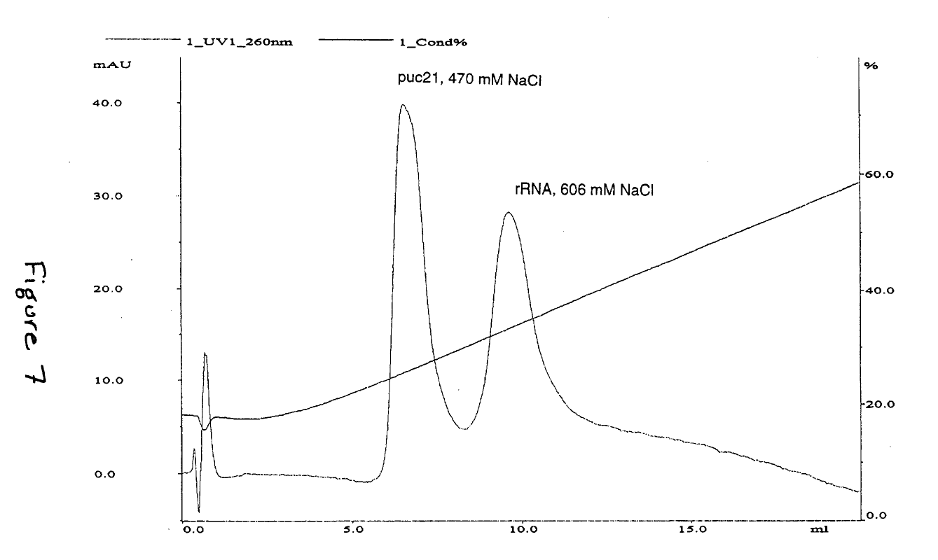

The separation and isolation of pDNA and rRNA on the anion-exchange resin QP4 are illustrated in FIG. 7

sieve fraction: 32-90 μm;

Nucleic acid sample: pDNA, rRNA (16S/23S);

Gradient of the eluant: 200 mM-800 mM NaCl.

The chromatograms illustrated in FIGS. 6 and 7 demonstrate that, with the use of this anion-exchange resin which an acrylate is used as the acrylic acid derivative in the polymerisation reaction, the elution sequence of pDNA and rRNA is reversed in comparison to that of the previously described anion-exchange resins in which acrylic acid amides are used.

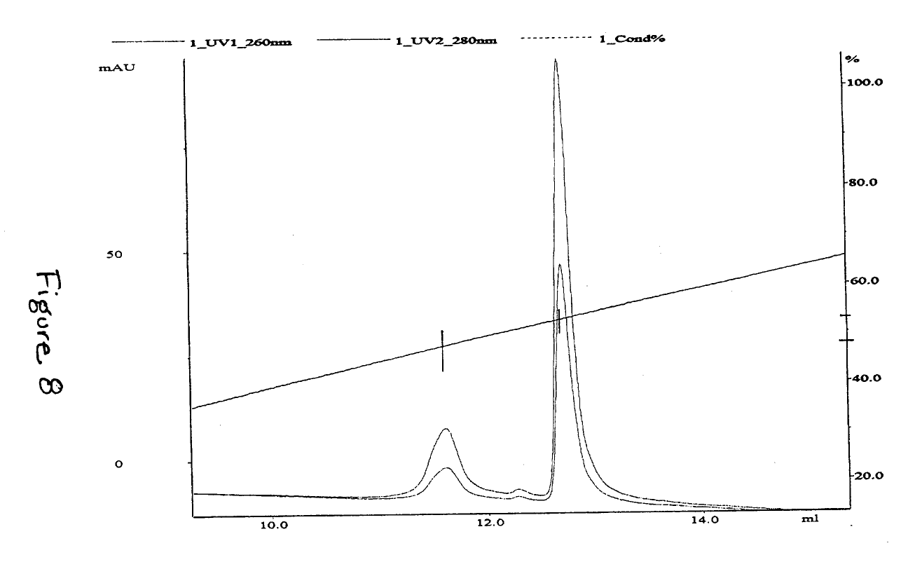

The separation and isolation of nucleic acids on TiO₂—particles coated with anion-exchange resin QP66Ti, are illustrated in FIG. 8.

Sieve fraction: 32-90 μm;

Nucleic acid sample: pDNA, rRNA (16S/23S);

Gradient: 880 mM-1200 mM NaCl.

The chromatogram clearly shows that the separation activity of the anion-exchange resin, as well as the elution sequence of the individual nucleic acid species, that is advantageous for the isolation of the p-DNA, even with the use of the anion-exchange resin as a coating, are maintained.

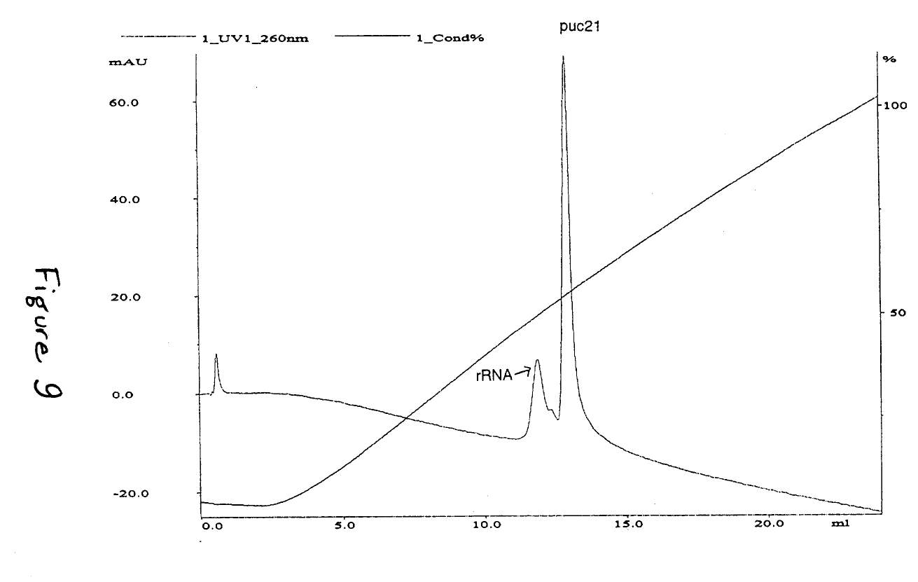

The separation and isolation of nucleic acids on SiO₂-particles that are coated with the anion-exchange resin QP66Si, are exhibited in FIG. 9.

Sieve fraction: 32-90 μm;

Nucleic acid samples: pDNA, rRNA (16S/23S);

Gradient of the eluant: 0 mM-1200 mM NaCl.

As in FIG. 8, the elution profile illustrated in FIG. 9 demonstrates that the separation capacity of the anion-exchange resin, as well as the elution sequence that is especially advantageous for the isolation of pDNA, even with its use as a coating, is maintained.

Table 4 indicates the dependence of the elution properties of a selected anion-exchange material upon the pH value of the eluant. It is clear from the table that the good RNA/pDNA separation capacity of the anion-exchange resin remains intact even when the pH value of the eluant and when the included buffer substances are varied.

TABLE 4

| | | | | | | DNA- |
|---|---|---|---|---|---|---|
| | Cross- | Pore- | | rRNA | pDNA | RNA |
| | linking | Promoting | Buffer/ | (16S/23S) | (NaCl)/ | (NaCl)/ |
| Resin | Agent | Agent | pH-value | (NaCl)/[M] | [mM] | [mM] |
| QP57-2 | EGDMA | PEG 4000 | TRIS-Buffer, pH | 0.78 | 0.87 | 94.0 |
| | | | 6.0 | | | |
| QP57-2 | ″ | PEG 4000 | TRIS-Buffer, pH | 0.77 | 0.86 | 97.0 |
| | | | 7.0 | | | |
| QP57-2 | ″ | PEG 4000 | Phosphate | 0.82 | 0.93 | 107.0 |
| | | | Buffer, pH 6.5 | | | |
| QP57-2 | ″ | PEG 4000 | Phosphate Buffer | 0.84 | 0.94 | 107.0 |
| | | | PH 6.0 | | | |

The abbreviations used in Table 4 correspond to those used in Table 1.

The abbreviations used in Table 4 correspond to those used in Table 1.

### EXAMPLE 5

5.1 Preparation of Puc21 from Clarified Bacterial Lysate

An LB-Ampicillin-Agar plate was smeared out with puc 21-transformed Eschirichia coli bacterial (Stamm: DH5α) (s.o.) and incubated at 37° C. over a period of about 12 hours.

5 ml of LB-medium (10 g of bacto-tryptone; 5 g of bacto-yeast extract; 10 g of NaCl in 1 litre of distilled water; pH 7.0 (NaOH), were treated with 5 μl of ampicilliin solution under sterile cover, and inoculated with a mono-colony. This pre-culture was incubated for 7 hours at 37° C. and at 200 rpm. 500 ml of LB-medium (10 g of bacto-tryptone; 5 g of bacto-yeast extract, 10 g of NaCl in 1 litre of distilled water; pH 7.0 (NaOH) ) in a 2 litre schikane flask were treated with 500 μl of ampicillin solution and 500 μl of pre-culture. The culture was incubated at 37° C. and at 110 rpm over a period of 12 hours, then transferred to a centrifuge capsule and the bacteria sedimented at 5000-6000 rpm for 20 minutes at 4° C.

Preparation of the Clarified Bacterial Lysate

The bacterial pellet was suspended in 10 ml of the following buffer. The buffer comprised 6.06 g of trisbase, 3.72 g of EDTA-disodium salt*2H₂O in 800 ml of distilled water. The pH of the buffer was brought to pH 8.0 with hydrochloric acid. 100 mg of RNase A were added to 1 litre of buffer. 10 ml of lysis buffer were added to the homogeneous bacterial suspension, which was mixed and incubated for 5 minutes at room temperature. The lysis buffer comprised 8.0 g of NaOH in 950 ml of distilled water as well as 50 ml of 20% sodium dodecyl sulphate. The lysate was treated with 10 ml of neutralisation buffer solution cooled with ice. The neutralisation buffer comprised 294.5 g of potassium acetate in 500 ml of distilled water. The pH value was brought to 5.5 with glacial acetic acid, and the volume brought up to 1 litre with distilled water.

The precipitate produced, that comprised genomic DNA, proteins, cell contents and potassium dodecyl sulphate, was separated by filtration (for example, QIA-filter, QIAGEN GmbH). The clarified bacterial lysate obtained was stored over-night at 4° C.

Four Leer columns comprising polypropylene filtration frit were each dry-packed with 150 mg of a 32-90 μm fraction QP66. In order to prevent churning up of the anion-exchange resin during operation of the column, without exerting pressure on the particle layer, a second polypropylene filtration frit layer was introduced over the anion-exchange resin. The columns were fixed in a holding frame and each irrigated with 1 ml of buffer (800 mM of NaCl, 50 mM of morpholine-propane-sulphonic acid with 15% by volume of EtOH, 0.15% by volume of Triton X-100; pH: 7.0). After no further buffer can be eluted from the columns, 0.9 ml of clarified lysate was added to each column. As soon as no further drops emerged from the columns, the columns were each washed four times with 1 litre of buffer (800 mM of NaCl, 50 mM of morpholine-propane sulphonic acid (MOPS), 15% of EtOH; pH: 7.0). Elution of the puc21 Dh5α was then carried out on each column with 0.8 ml of buffer (1250 mM of NaCl, 50 mM of Tris, 15% by volume of iso-propanol; pH: 8.5). The eluates were then each treated with 0.56 ml of iso-propanol, and then centrifuged in a table centrifuge for 30 minutes at 10,000 rpm. The excess was then carefully decanted from the precipitated pDNA. The pDNA was then washed again with 1 ml of 70% by volume of ethanol, re-centrifuged, the excess carefully decanted and the precipitated pDNA was in each case taken up into 300 μl of buffer (10 mmol of TRIS and 1 mmol of EDTA; pH: 8.0). For the determination of the concentration, the OD (optical density) of 150 μl of buffer (10 mmol TRIS and 1 mmol of EDTA: pH: 8.0) was measured in a quartz cuvette at 260 nm (1 OD corresponds to a pDNA concentration of 0.05 μg/μl). The measurements are presented in the Table 5.

TABLE 5
Determination of the pDNA-Concentration

| OD | Puc21/[μg/μl] | Total Yield, puc21/[μg] |
|---|---|---|
| 0.499 | 0.0249 | 7.48 |
| 0.496 | 0.0248 | 7.44 |
| 0.501 | 0.0251 | 7.52 |
| 0.487 | 0.0244 | 7.32 |

5.2 Preparation of pBR322 from Clarified Bacterial Lysate

The preparation is carried out in an analogous manner to that of Example 5.1.

The separation of the pDNA from the available RNA in the lysate on an agar gel, is illustrated in the FIG. 10.

The abbreviations used are:

M=standard molecular weight, L=Clarified lysate

W1=First washing stage, W2=Second Washing stage and E=Eluate

### EXAMPLE 6

Determination of the Puc21 Binding Capacity

This test was used to determine the pDNA binding capacity. A specific amount of anion-exchange resin was equilibrated with a defined volume of pDNA solution in a known concentration for a determined period of time. The anion-exchange resin was then pipetted quantitatively into a Leer column having a frit (see above). The material was washed with buffer and then the bound pDNA was eluted with a buffer of higher salt concentration. The concentration of the pDNA was determined photometrically at 260 nm.

Procedure

The anion-exchange resins QP 66, QP66Si, QP66Ti, QP71 and QP71 CIP were placed into Eppendorf vessels. 1 ml of a 200 μg (400 μg) of pDNA-containing buffer solution (10 mmol TRISbase, 1 mmol of EDTA; pH: 8.0) (see above) was pipetted into them, briefly thoroughly mixed and then equilibrated for 5 minutes in a shaker (for example, an ‘end-over-end’ shaker). The anion-exchange resin was pipetted into a Leer column provided with frit, and residual anion-exchange resin removed from the Eppendorf vessel with 0.9 ml of buffer (0.2M NaCl, 50mM MOPS; pH: 7.0), and likewise passed into the Leer column. All columns were filled to the same level with the different materials. Because of the different bulk densities of the anion-exchangers used, different material weighings were obtained, as indicated in the Table 6.

Each column was washed with 1 ml of buffer (46.75 g of NaCl, 10.46 g of morpholino-propane sulphonic acid (MOPS), and 150 ml of iso-propanol and made up to 1 litre with distilled water; pH: 7.0), and the pDNA was eluted with 1 ml of buffer (73.05 g of NaCl, 6.06 g of TRIS base, 150 ml of iso-propanol, made up to 1 litre with distilled water; pH: 8.5). 250 μl of the eluate per 1 ml, were diluted with buffer (73.05 g NaCl, 6.06 g of TRIS base, and 150 ml of iso-propanol, made up to 1 litre with distilled water; pH: 8.5), and the optical density (OD) was determined at 260 nm. In the event that almost all of the tendered, 200 μg of the pDNA amount is adsorbed, the test was repeated and the pDNA amount doubled.

All other anion-exchange resins were used in such amounts that the levels reached in the Leer column corresponded to the levels reached by 50 mg of reference anion-exchange resin in the same column.

TABLE 6

| | Weigh-in | 200 μg of puc21 | 400 μg of puc21 |
|---|---|---|---|
| | [mg] | Yield of pDNA | Yield of pDNA |
| QP66 | 20 | 176.7 | 298.5 |
| QP66Si | 70 | 45.4 | 46.4 |
| QP66Ti | 185 | 171.2 | 314.1 |
| QP71 | 19 | 162.1 | 267.4 |
| QP71 CIP | 19 | 162.3 | 269.2 |

### EXAMPLE 7

Determination of the Dynamic Binding Capacity

RNase-digested and clarified bacterial lysate from un-transformed Escherichia coli (Stamm: DH5α) was added to a determined amount of pDNA. Into each of eight Leer columns packed with QP66 to identical levels (corresponding to 60 mg), was added 1.00 ml, 1.05 ml, 1.10 ml and 1.15 ml -corresponding to 100-, 150-, 200- and 250 μg of puc21 in clarified DH5α lysate. The columns were washed with buffer and the pDNA eluted with 800 μl of high-salt buffer (1250 mM of NaCl, 50 mM of Tris, 15% by volume of isopropanol; pH: 8.5). From a 200 μl aliquot of the eluate, the pDNA was pelleted after addition of 140 μl of isopropanol and centrifugation at 10,000 rpm. The pellet was washed with isopropanol, and air-dried. The dry pellet was dissolved in 20 μl of buffer (10 mmol of TRIS-base, 1 mmol of EDTA; pH: 8.0), and the OD determined at 260 nm. The yield from the aliquot was used to calculate the total yield of pDNA from 900 μl of eluate. The measurements are listed in Table 7.

TABLE 7
Double calculation of the dynamic binding capacity

| Puc21 in clarified | Yield of pDNA with |
|---|---|
| Lysat/[μg] | QP66/[μg] |
| 100/1 | 74.6 |
| 100/2 | 72.6 |
| 150/1 | 109.6 |
| 150/2 | 105.6 |
| 200/1 | 135.6 |
| 200/2 | 151.8 |
| 250/1 | 163.7 |
| 250/2 | 166.5 |

### EXAMPLE 8

Determination of the Exchange Capacity of Selected Anion-Exchange Resins

About 100 mg of a 32-90 μm sieve-fraction of anion-exchange resin was filled into a Leer column provided with polypropylene frit. The particle layer was covered with a further polypropylene frit and a defined volume of 0.1 molar hydrochloric acid (for the amounts, see the following table) was added to the column. After the added volume had passed through, the column was rinsed with 4×500 μl of distilled water. The purified eluates were back-titrated with 0.1 molar NaOH against neutral red. The following Table 8 presents the volumes of the normal solutions, the bulk densities of the polymers and the derived exchange capacities in mmol per unit/g and in mmol/ml.

TABLE 8
Determination of the Exchange Capacities

| | | | Volume of | Used | | |
|---|---|---|---|---|---|---|
| | Weigh-in | Bulk Density | 0.1 M HCl | 0.1 M NaOH | Capacity | Capacity |
| Polymer | [g/ml] | [g/ml] | [ml] | [μl] | [mmol/g] | [mmol/ml] |
| QP57-2 | 100.0 | 0.157 | 2.5 | 750 | 1.75 | 0.275 |
| QP71-OA | 100.5 | 0.184 | 3.0 | 1525 | 1.52 | 0.280 |
| QP18 | 108.7 | 0.598 | 1.5 | 900 | 0.55 | 0.330 |
| QP66Ti | 253.7 | 1.400 | 1.0 | 500 | 0.20 | 0.280 |
| QP71-A | 109.0 | 0.218 | 2.5 | 650 | 1.51 | 0.330 |
| QP58-1 | 25.2 | 0.139 | 0.5 | 300 | 1.19 | 0.165 |
| QP58-4 | 64.2 | 0.118 | 1.0 | 200 | 1.25 | 0.148 |

1. An anion-exchange resin that is obtainable through the polymerisation of at least one acrylic acid derivative together with at least one cross-linking agent, in which the acrylic acid derivative corresponds to the general formula (I): 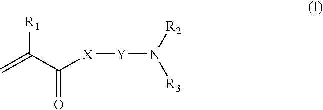
And R₁ represents hydrogen, a methyl- or ethyl group, R₂ and R₃, that are unconnected to one another, represent hydrogen, a C₁-C₃-alkyl group or a hydroxyl-substituted C₁-C₃-alkyl group, X represents an —(NH)— group or an —(NR₄)— group, and R₄ represents a C₁-C₃-alkyl group, and Y represents a (CH₂)ₘ—(CH2O)ₙ— group, in which m and n are independent of one another and denote the whole numbers 0, 1, 2, 3, 4, 5 or 6, in which m+n is >0 and one or both of the hydrogens of the Y group can be replaced by a C₁-C₃-alkyl group or by an acrylic acid derivative of the general formula (II): 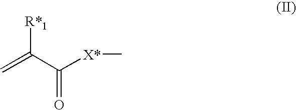
and in which R*₁ represents hydrogen, a methyl- or ethyl-group, and X represents oxygen or an —(NH)— group,
in which the cross-linking agent corresponds to the general formula (III): 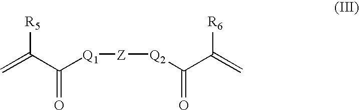
and R₅ and R₆ are independent of one another and represent hydrogen, a methyl- or ethyl group, and Q₁ and Q₂ represent oxygen, and Z represents a {[(CH₂)ₒ]O}ₚ—(CH₂)_{q} group, in which o, p and q are independent of one another and denote whole numbers 0, 1, 2 or 3 and o+p+q is >0, and in which at least one hydrogen atom in the Z group can be replaced by a C₁-C₃-alkyl group or an —[(CH₂)ᵣ—O]ₛ—(CH₂)ₜ—NR₈R₉ group, that are independent of one another, in which r, s and t, independently of one another, represent the whole number 0, 1, 2, 3, 4, 5 or 6, and r+s+t is >0, and R₈ and R₉ are independent of one another and represent hydrogen, a C₁-C₃-alkyl group or a hydroxyl-substituted C₁-C₃-alkyl group.

2. An anion-exchange resin, according to claim 1, characterised in that the selected acrylic acid derivative is one from the group comprising N-[3-(N,N-dimethylamino)-propyl]methacrylamide, N-[3-(N,N-diethylamino)-propyl]methacrylamide, N-[2-(N,N-dimethylamino)-ethyl]methacrylamide and N-[2-(N,N-diethylamino)-ethyl) methacrylamide.

3. An anion-exchange resin according to one of claims 1 or 2, characterised in that the cross-linking agent is selected from the group of alkylidene-glycol diacrylates or of dialkylidene-glycol diacrylates, and preferably from the group comprising ethylene-glycol dimethacrylate, 2,2-dimethyl-1,3-propanediol diacrylate, 2,2-dimethyl-1,3-propanediol dimethacrylate, diethylene-glycol diacrylate, diethylene-glycol dimethacrylate, ethylene-glycol diacrylate, dipropylene-glycol dimethacrylate and 3-(N,N-dimethylamino-propyl)-1,2-diacrylate.

4. An anion-exchange resin, according to one of claims 1 to 3, characterised in that the acrylic acid derivative is N-[3-(N,N-dimethylamino)-propyl]-methacrylamide and the cross-linking agent is ethylene-glycol dimethacrylate.

5. An anion-exchange resin according to one of claims 1 to 4, characterised in that the cross-linking agent is ethylene-glycol dimethacrylate.

6. An anion-exchange resin according to one of claims 1 to 5, characterised in that it is produced by way of a radical polymerisation.

7. An anion-exchange resin according to one of the previous claims, characterised in that a protic or aprotic solvent is used in the radical polymerisation, especially water, methanol, ethanol, iso-propanol, ethylene-glycol, ethylene-glycol-monalkyl-ether, glycerine, dimethyl formamide and/or dimethyl sulphoxide.

8. An anion-exchange resin according to one of claims 1 to 7, characterised in that a pore-promoting agent is added to the polymerisation.

9. An anion-exchange resin according to claim 8, characterised in that the pore-promoting agent is an aliphatic alcohol, that is branched or un-branched, having 4 to 20 C-atoms, or is a polymeric compound whose mean molar molecular weight M_{w} lies between 200 and 100,000 g/mol, and is selected from the group comprising polyalkylidene-glycol derivatives, polyethylene-imine, polyvinyl-pyrollidone and polystyrene.

10. An anion-exchange resin according to claims 8 and 9, characterised in that the pore-promoting agent is an aliphatic, branched or un-branched alcohol having 4 to 20 carbon atoms, preferably 4 to 16 carbon atoms, and especially preferably 4 to 8 carbon atoms, and with one or several hydroxyl groups, preferably 1 to 3 hydroxyl groups.

11. An anion-exchange resin according to one of the claims 8 to 10, characterised in that the pore-promoting agent is selected from the group comprising
Polyethylene glycol having an Mw of between 200 to 10,000 g/mol,
Polypropylene glycol having an Mw of between 200 to 10,000 g/mol,
Polyethylene-glycol monoalkyl ether having an Mw of between 200 to 5,000 g/mol,
Polyethylene-glycol dialkyl ether having an Mw of between 200 to 5000 g/mol,
Polyethylene-glycol monoalkyl ester having an Mw of between 200 to 20,000 g/mol,
Polyethylene-glycol dialkyl ester having an Mw of between 200 to 5,000 g/mol,
Polyethylene-glycol diacid having an Mw of between 1,000 to 20,000 g/mol,
Polyethylene-imine having an Mw of between 200 to 10,000 g/mol,
Polyvinyl-pyrrolidone having an Mw of between 10,000 to 40,000 g/mol, or
Polystyrene having an Mw of between 200 to 5,000 g/mol.

12. An anion-exchange resin according to one of claims 8 to 11, characterised in that the pore-promoting agent has an Mw of between 1,000 to 6,000 g/mol.

13. An anion-exchange resin according to one of claims 1 to 12, characterised in that the reaction mixture comprises 0.1 to 100% by weight of an acrylic acid derivative, 0 to 95% by weight of a cross-linking agent, 0 to 75% by weight of a solvent, and 0 to 75% by weight of a pore-promoting agent.

14. An anion-exchange resin according to one of claims 1 to 13, characterised in that the reaction mixture comprises 0.1 to 75% by weight of an acrylic acid derivative, 0 to 75% by weight of a cross-linking agent, 0 to 60% by weight of a solvent and 0 to 50% by weight of a pore-promoting agent.

15. An anion-exchange resin according to one of claims 1 to 14, characterised in that the reaction mixture comprises 16.5% by weight of an acrylic acid derivative, 13.5% by weight of a cross-linking agent, 49% by weight of a solvent and 21% by weight of a pore-promoting agent.

16. An anion-exchange resin according to at least one of the previous claims, characterised in that the anion-exchange resin is used in particle form having a particle diameter of between 1 to 10,000 μm.

17. An anion-exchange resin according to one of claims 1 to 15, characterised in that the anion-exchange resin is used in the form of a membrane.

18. An anion-exchange resin according to one of claims 1 to 15, characterised in that the anion-exchange resin used is in the form of a monolithic column.

19. An anion-exchange resin according to one of claims 1 to 15, characterised in that the anion-exchange resin is used as a coating on a carrier material.

20. The use of any of the anion-exchange resins according to one of claims 1 to 19, in a chromatographic procedure.

21. The use of any one of the anion-exchange resins according to claim 20, characterised in that the chromatographic procedure is undertaken in a cleaning process, in an analytical procedure or in a production process.

22. The use of an anion-exchange resin according to claim 20 or 21, characterised in that the anion-exchange resin is used in an automated cleaning process and/or in an isolating process and/or in an analytical procedure.

23. The use of an anion-exchange resin according to one of claims 20 to 22, characterised in that nucleic acids from a nucleic acid-containing mixture are separated, isolated, analysed and/or purified in the chromatographic process.

24. The use of an anion-exchange resin according to one of claims 20 to 23, characterised in that the anion exchange resin is used for the isolation of plasmid-DNA, preferably for the isolation of p-DNA from E-coli lysates.

25. A kit for the isolation and/or purification of high-molecular weight nucleic acids, utilizing at least one of the anion-exchange resins as defined in claims 1 to 19.

26. A kit according to claim 25, additionally utilizing a suitable buffer.

27. A pharmaceutical compound containing at least one of the anion-exchange resins as defined in claims 1 to 19.

28. A diagnostic compound that contains at least one of the anion-exchange resins as defined in claims 1 to 19.

29. A compound used for research purposes, that contains at least one anion-exchange resin as defined in claims 1 to 19.

30. A process for the production of one of the anion-exchange resins as defined in one the claims 1 to 19, which comprises the following stages:
a) If necessary, the de-protection of the acrylic acid derivative and/or of the cross-linking agent;
b) The production of the monomeric mixture;
c) The addition of a solvent, if necessary of a radical starter or a pore-promoting agent;
d) De-gassing of the reaction mixture; and
e) Polymerisation at 60° C. over a period of 12 to 24 hours.

31. A process according to claim 30, characterised in that the anion-exchange resin is produced by a radical polymerisation.

32. A process according to claim 30, characterised in that the anion-exchange resin is produced means of a suspension- or emulsion polymerisation.

33. A process according to claim 31, characterised in that 4 to 20% by weight of acrylic acid derivative, 10 to 23% by weight of cross-linking agent, 3 to 60% by weight of solvent and/or 5 to 35% by weight of pore-promoting agent are used, the reaction temperature is 50-80° C., the initiation of the radical polymerisation is promoted with the use of 2,2′-azo-bis-isobutyronitrile (AIBN), and/or benzoyl peroxide (BPO), and/or isopropanoyl peroxide (IPPO), and/or sodium-, potassium- or ammonium peroxide disulphate, or by means of UV-irradiation or γ-irradiation, and the reaction proceeds for a period of 12 to 28 hours.

34. A process for the production of an anion-exchange resin as defined in claim 19, characterised in that the following stages are undertaken:
a) If necessary, loading the carrier particles with a radical starter;
b) Addition of the acrylic acid derivative and the cross-linking agent, if necessary of the pore-promoting agent, and of the solvent;
c) Thorough mixing of the reaction mixture;
d) Removal of the excess reaction mixture from the carrier particles;
e) Polymerisation at 60° C. over a period of 12 to 24 hours; and
f) Washing of the coated carrier material.
